(19) United States
(12) Patent Application Publication
(10) Pub. No.: US 2026/0014855 A1
(43) Pub. Date: Jan. 15, 2026

(54) WORK VEHICLE AND DRIVE ASSEMBLY WITH FRONT-REAR DIFFERENTIAL

(71) Applicant: Deere & Company, Moline, IL (US)

(72) Inventors: Randall L. Long, Coffeyville, KS (US); Briton T. Eastman, Coffeyville, KS (US)

(21) Appl. No.: 18/771,121

(22) Filed: Jul. 12, 2024

(51) Int. Cl. B60K 23/08; B60K 17/342; B60K 17/356; E02F 9/20; F16H 37/08; F16H 48/24

(52) U.S. Cl. CPC B60K 23/08; B60K 17/342; B60K 17/356; E02F 9/202; E02F 9/2079; F16H 37/082; F16H 48/24; B60K 2023/0875

(57) ABSTRACT

A drive assembly for a work vehicle having front and rear ground engaging members. The drive assembly includes a drive motor, a gear assembly driven by the drive motor, and a limited differential assembly. The limited differential assembly includes front and rear drive elements mechanically coupled to the respective front and rear ground engaging members, a power transmission ring driven by the gear assembly, and a disconnect ring mechanically coupled to the power transmission ring. The power transmission ring being coupled to the rear drive element. When the front drive element is in a first position, the power transmission ring is engaged with the front drive element. When the front drive element is in a second position, the power transmission ring is disengaged from the front drive element to not drive the front ground engaging member and permit the front and rear ground engaging members to rotate at different speeds.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure generally relates to a drive assembly of a work vehicle.

### BACKGROUND OF THE DISCLOSURE

Some work vehicles have traction-based steering, where the work vehicle is steered by movement of ground engaging members on the right and/or the left side of the work vehicle to orient the work vehicle to a desired direction. One example of a traction-based steering work vehicle is a skid steer loader. The work vehicle moves and steers based on the traction the ground engaging members have with the ground surface. Improving this traction can improve the control the operator has when moving the work vehicle.

### SUMMARY OF THE DISCLOSURE

In one implementation, a drive assembly for a work vehicle includes a drive motor, a gear assembly driven by the drive motor, and a limited differential assembly. The limited differential assembly includes front and rear drive elements mechanically coupled to front and rear ground engaging members of the work vehicle, a power transmission ring driven by the gear assembly to rotate about a drive axis, and a disconnect ring mechanically coupled to the power transmission ring to rotate about the drive axis. The power transmission ring being coupled to the rear drive element to drive rotation of the rear ground engaging member. When the front drive element is in a first position the power transmission ring is engaged with the front drive element to drive rotation of the front ground engaging member, and when the front drive element is in a second position, the power transmission ring is disengaged from the front drive element so as not to drive rotation of the front ground engaging member and permit the front and rear ground engaging members to rotate at different speeds.

In an example of the drive assembly, the limited differential assembly further includes a biasing member to apply a biasing force to the front drive element to bias the front drive element toward the power transmission ring and into the first position. The front drive element transitions from the first position to the second position based on a force generated by interactions between a ground surface and the front ground engaging member overcoming the biasing force. These interactions cause the front ground engaging member to rotate at a different speed than the rear ground engaging member.

In a further example of the drive assembly, in the first position, the front drive element is mechanically engaged with the disconnect ring at a cam interface. The front drive element transitions from the first position to the second position by cam action at the cam interface. In a further example of the drive assembly, in the first position and in the second position, the power transmission ring comprises a plurality of radial splines mechanically engaged with a plurality of radial splines of the rear drive element. In a further example of the drive assembly, the front drive element is positioned along the drive axis on a first side of the limited differential assembly, and the rear drive element is positioned along the drive axis on a second side of the limited differential assembly opposite the first side.

In a further example of the drive assembly, the power transmission ring comprises a spline positioned on an inner circumference of the power transmission ring, the spline is mechanically engaged with an output of the gear assembly, and the power transmission ring is driven by the output of the gear assembly. In a further example of the drive assembly, the power transmission ring comprises an outer circumference engaging feature, the disconnect ring comprises an inner circumference engaging feature, and the disconnect ring is driven by the power transmission ring based on the outer circumference engaging feature mechanically engaging with the inner circumference engaging feature to transfer movement of the power transmission ring to the disconnect ring.

In a further example of the drive assembly, the front drive element defines an axial channel, the limited differential assembly further comprises a locating ring at least in part positioned in the axial channel, and the locating ring maintains alignment of the front drive element and the power transmission ring in the first position and in the second position. In a further example of the drive assembly, the rear drive element defines a second axial channel aligned with the axial channel, the limited differential assembly further includes a second locating ring positioned in the second axial channel, and the second locating ring maintains alignment of the rear drive element and the power transmission ring in the first position and in the second position. In a further example of the drive assembly, the power transmission ring and the disconnect ring together define a radial channel, a snap ring is positioned within the radial channel to maintain alignment of the power transmission ring and the disconnect ring, and the snap ring is positioned between the axial channel and the second axial channel.

In a further example of the drive assembly, the rear drive element includes a sprocket mechanically coupled to the rear ground engaging member by a continuous elongated member. In a further example of the drive assembly, the gear assembly is a planetary gear set.

In one implementation, a work vehicle includes a chassis and a drive assembly. The chassis mounts a front ground engaging member and a rear ground engaging member. The drive assembly includes a drive motor, a gear assembly driven by the drive motor, and a limited differential assembly. The limited differential assembly includes front and rear drive elements mechanically coupled to the respective front and rear ground engaging members, a power transmission ring driven by the gear assembly to rotate about a drive axis, and a disconnect ring mechanically coupled to the power transmission ring to rotate about the drive axis. The power transmission ring being coupled to the rear drive element to drive rotation of the rear ground engaging member. When the front drive element is in a first position, the power transmission ring is engaged with the front drive element to drive rotation of the front ground engaging member, and when the front drive element is in a second position, the power transmission ring is disengaged from the front drive element so as not to drive rotation of the front ground engaging member and permit the front and rear ground engaging members to rotate at different speeds.

In an example of the work vehicle, the front and rear ground engaging members are located at a first side of the work vehicle, the chassis mounts a second front ground engaging member and a second rear ground engaging member both located at a second side of the work vehicle opposite the first side, and the work vehicle further includes a second drive assembly for driving rotation of the second front and rear ground engaging members independently of the drive assembly driving the front and rear ground engaging members. The second drive assembly includes a second drive motor, a second gear assembly driven by the second drive motor, and a second limited differential assembly. The second limited differential assembly includes a second front drive element and a second rear drive element mechanically coupled to the respective second front and rear ground engaging members, a second power transmission ring driven by the second gear assembly to rotate about a second drive axis, and a second disconnect ring mechanically coupled to the second power transmission ring to rotate about the second drive axis. The second power transmission ring being coupled to the second rear drive element to drive rotation of the second rear ground engaging member. When the second front drive element is in a first position, the second power transmission ring is engaged with the second front drive element to drive rotation of the second front ground engaging member, and when the second front drive element is in a second position, the second power transmission ring is disengaged from the second front drive element so as not to drive rotation of the second front ground engaging member and permit the second front and rear ground engaging members to rotate at different speeds.

In a further example of the work vehicle, the limited differential assembly further comprises a biasing member to apply a biasing force to the front drive element to bias the front drive element toward the power transmission ring and into the first position. The front drive element transitions from the first position to the second position based on a force generated by interactions between a ground surface and the front ground engaging member overcoming the biasing force. These interactions cause the front ground engaging member to rotate at a different speed than the rear ground engaging member.

In a further example of the work vehicle, in the first position, the front drive element is mechanically engaged with the disconnect ring at a cam interface, and the front drive element transitions from the first position to the second position by cam action at the cam interface. In a further example of the work vehicle, in the first position and in the second position, the power transmission ring comprises a plurality of radial splines mechanically engaged with a plurality of radial splines of the rear drive element. In a further example of the work vehicle, the front drive element is positioned along the drive axis on a first side of the limited differential assembly, and the rear drive element is positioned along the drive axis on a second side of the limited differential assembly opposite the first side.

In a further example of the work vehicle, the power transmission ring includes a spline positioned on an inner circumference of the power transmission ring, the spline is mechanically engaged with an output of the gear assembly, and the power transmission ring is driven by the output of the gear assembly. In a further example of the work vehicle, the power transmission ring includes an outer circumference engaging feature, the disconnect ring includes an inner circumference engaging feature, and the disconnect ring is driven by the power transmission ring based on the outer circumference engaging feature mechanically engaging with the inner circumference engaging feature to transfer movement of the power transmission ring to the disconnect ring.

### BRIEF DESCRIPTION OF THE DRAWINGS

FIG. 1 is a simplified perspective view of an example work vehicle, according to at least one aspect of the present disclosure;

FIG. 2 is a simplified schematic of the drive train of the work vehicle of FIG. 1, according to at least one aspect of the present disclosure;

FIG. 3 is a perspective view of an example drive assembly, according to at least one aspect of the present disclosure;

FIG. 4 is a perspective view of the drive assembly of FIG. 3 with some components removed, according to at least one aspect of the present disclosure;

FIG. 5 is a cross-sectional view of the drive assembly of FIG. 3 taken along the cross-section line 5-5 with the limited differential assembly in the engaged position, according to at least one aspect of the present disclosure;

FIG. 6 is a cross-sectional view of the drive assembly of FIG. 3 taken along cross-section line 5-5 with the limited differential assembly in the disengaged position, according to at least one aspect of the present disclosure;

FIG. 7 is a simplified exploded view of the limited differential assembly and output shaft of the drive assembly of FIG. 3, according to at least one aspect of the present disclosure;

FIG. 8 is a perspective view of some internal components of the limited differential assembly of FIGS. 5 and 6, according to at least one aspect of the present disclosure;

FIG. 9 is an exploded view of the internal components of FIG. 8, according to at least one aspect of the present disclosure; and

FIG. 10 is a side view of the internal components of FIG. 8 with a locating ring removed, according to at least one aspect of the present disclosure.

Throughout the drawings, identical reference numbers designate the same element. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Example embodiments of the present disclosure are shown in the accompanying figures of the drawings described briefly above. Various modifications to the example embodiments may be contemplated by one of skill in the art without departing from the scope of the present invention, as set forth in the appended claims.

### OVERVIEW

Work vehicles with traction-based steering are steered by movement of ground engaging members on the right and/or the left side of the work vehicle for orientation and movement of the work vehicle. The traction can be improved by allowing a speed differential between front and rear ground engaging members (e.g., wheels or tracks) on the right and left sides of the work vehicle. A work vehicle with traction-based steering can have a right drive assembly for the right side and a left drive assembly for the left side, where the right and left drive assemblies operate independently. The left drive assembly can drive a front and a rear ground engaging member on the left side and the right drive assembly can drive a front and a rear ground engaging member on the right side. The amount of power that can be produced by the left or right drive assembly is fixed. Each drive assembly can include a limited differential assembly that splits the power between the front and rear ground engaging members. To improve the traction between the front and rear ground engaging members and the ground, the limited differential assembly can allow at times one ground engaging member to slip causing a speed differential between the front and rear ground engaging members. This process allows one ground engaging member to be provided with all of the driving power of the drive assembly. The speed differential can be based on the traction and interactions between the ground and the front and rear ground engaging members. For example, the left front ground engaging member can rotate at a different speed than the left rear ground engaging member based on the traction between the left ground engaging members and the ground. This process can improve the overall traction of the ground engaging members of the work vehicle by allowing one ground engaging member to rotate freely based on its traction with the ground and driving the other ground engaging member with the drive assembly.

The limited differential can provide constant power to one ground engaging member and allow the other ground engaging member to slip. For example, the limited differential assembly can be designed to allow a specific output to slip and always drive the other output. The limited differential assembly can include an output interface that rotates two driving elements, where a first drive element is always engaged and a second drive element can either be engaged or disengaged with the output interface. When the second drive element is disengaged, the second drive element can rotate independently from the output interface. The drive element allowed to slip and the drive element being constantly driven can be chosen by the design of the limited differential assembly. For example, the manufacturer can decide which drive element (e.g., front or rear drive element) is allowed to slip.

The manufacturer can make the decision of which drive element slips to provide the best traction to the work vehicle. For example, the wheels at the front of the work vehicle could be different (e.g., in wheel diameter or tread width) than at the rear or the front or rear wheels could carry different loads. Where the rear wheels are larger and carry a larger portion of the load, for example, the manufacturer could have the rear wheels constantly driven and allow the front wheels to slip. This would allow the rear wheels with more surface area touching the ground to be driven constantly and provide more consistent tractive power to complete a work operation.

The drive assembly can be designed to position the limited differential assembly at different locations on the work vehicle. For example, the limited differential assembly can be positioned at the front ground engaging member, where a front drive element is mechanically engaged with the front ground engaging member, and a rear drive element is mechanically coupled to the rear ground engaging member through a continuous elongated member (e.g., a chain or a belt) or a gearing system. In an alternative example, the limited differential assembly can be positioned between the front and rear ground engaging members, where a front drive element is mechanically coupled to the front ground engaging member through a continuous elongated member or gearing system and a rear drive element is mechanically coupled to the rear ground engaging member through another continuous elongated member or another gearing system. In yet another alternative example, the limited differential assembly can be positioned at the rear ground engaging member, where a front drive element is mechanically coupled to the front ground engaging member through a continuous elongated member or gearing system, and a rear drive element is mechanically engaged to the rear ground engaging member. In any of these configurations, the limited differential assembly can be designed to allow power to always be provided to either the front or rear ground engaging member and allow the respective other ground engaging member to slip. For example, the limited differential assembly can be attached directly to one ground engaging member and allow the other ground engaging member to slip and rotate at a different speed than the directly attached ground engaging member.

A drive element of the limited differential assembly can passively (e.g., automatically) transition from an engaged position to a disengaged position based on interactions between a ground engaging member and the surface of the ground. The drive element is mechanically coupled to the ground engaging member to drive the ground engaging member. As such, movement of the drive element moves the ground engaging member. In the engaged position, the drive element is driven by a motor, and in the disengaged position, the drive element rotates based on the movement of the work vehicle and interactions between the ground engaging member and the ground surface. Rotational forces applied to the ground engaging member through interactions with the surface of the ground can be applied to the drive element through the mechanical coupling. A first rotational force can be supplied to the drive element by the motor to move the ground engaging member. The ground engaging member can move on the surface of the ground and generate a second rotational force applied to the drive element through the mechanical coupling between the drive element and the ground engaging member. If the second rotational force is greater than a threshold value, then the second rotational force can cause the drive element to move from the engaged position to the disengaged position. This process can passively occur without any active or complex control to allow a specific ground engaging member to rotate at a different speed than another ground engaging member due to interactions with the ground surface.

The front and rear ground engaging member can have different interactions with the ground surface. Due to the different interactions, the traction of the work vehicle can be improved by allowing a speed differential to occur between the front and rear ground engaging members on each side of the work vehicle. If the work vehicle has traction-based steering, then the steering can also be improved by improving the traction. The different interactions between the front and rear ground engaging members and the ground can be caused by different amounts of wear on the front and rear ground engaging members, different sizes between the front and rear ground engaging members, and the front and rear ground engaging members interacting with differing terrains.

The limited differential assembly can receive an input from a gear assembly that is driven by a motor. The gear assembly can include a variety of gear trains. For example, the gear assembly can include one or more planetary gear trains, one or more simple gear trains, one or more complex gear trains, one or more reverted gear trains, or combinations thereof. The output of the gear assembly can be used as an input to the limited differential assembly. One example gear assembly can include a planetary gear set to provide a gear reduction and simple integration with a brake.

An example limited differential assembly can include a power transmission ring, a disconnect ring, a first drive element, and a second drive element. The power transmission ring, the disconnect ring, the first drive element, and the second drive element can all be positioned and rotate on the same drive axis. The power transmission ring can be positioned within the disconnect ring, where the power transmission ring is circumferentially engaged with the disconnect ring. The first drive element can interface with the power transmission ring and the disconnect ring on a first side of the power transmission ring, and the second drive element can interface with the power transmission ring and the disconnect ring on a second side opposite the first side. The power transmission ring can receive an input from the gear assembly to drive the disconnect ring, the first drive element, and the second drive element. In the engaged position, the first drive element is driven by the power transmission ring and in the disengaged position the first drive element rotates at a different speed than the power transmission ring. The first drive element could drive a front ground engaging member or a rear ground engaging member with the second drive element driving the other ground engaging member.

The first drive element can interact with the disconnect ring to move from the engaged position to the disengaged position. The first drive element can drive a first ground engaging member. A rotational force generated by interactions between the first ground engaging member and the surface of the ground can be applied to the first drive element. The rotational force can cause the first drive element to rotate at a different speed than the power transmission ring and disconnect ring causing the first drive element to interact with the disconnect ring to move from the engaged position to the disengaged position. The second drive element drives a second ground engaging member and the second drive element is driven by the power transmission ring in the engaged and disengaged positions. In the disengaged position, the second ground engaging member moves the work vehicle. Since all the ground engaging members are mounted to the work vehicle, eventually the first drive element beings to move at a speed similar to the disconnect ring and power transmission ring. As the speed of the first drive element becomes similar to the disconnect ring and power transmission ring, the first drive element interacts with the disconnect ring to move from the disengaged position to the engaged position.

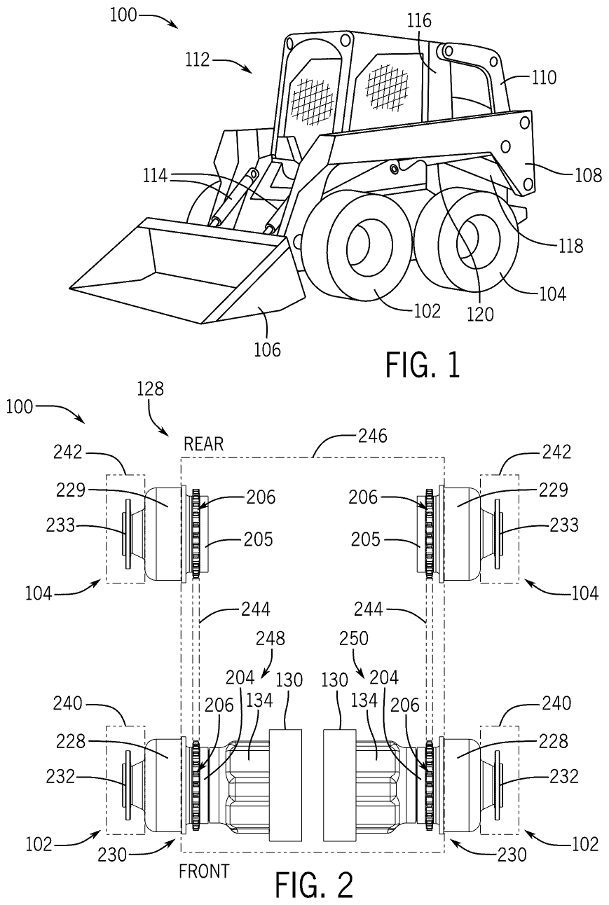

An example embodiment of a drive assembly of a work vehicle is provided in FIGS. 1-10 according to the present disclosure. The following description should be understood as merely providing a non-limiting example context in which embodiments of the present disclosure may be better understood.

### Example Work Vehicle and Drive Assembly with Front-Rear Differential

Referring to FIG. 1, a skid steer loader 100 is an example of a work vehicle that has traction-based steering. The skid steer loader 100 can include a limited differential assembly as discussed above. The skid steer loader 100 includes a pair of front ground engaging members 102 and a pair of rear ground engaging members 104 for moving along the ground. The ground engaging members 102, 104 can be wheels or tracks. The ground engaging members 102, 104 on the right side of the skid steer loader 100 can be operated independently from the ground engaging members 102, 104 on the left side of the skid steer loader 100. An operator can manipulate controls from inside a cab 112 to drive the ground engaging members 102, 104 on the right or left side of the skid steer loader 100 at different speeds to thereby steer and move the skid steer loader 100. For example, the operator can have the right ground engaging members 102, 104 rotate clockwise and the left ground engaging members rotate counterclockwise to turn the skid steer loader 100.

The skid steer loader 100 can be equipped with a work implement or tool for performing a work operation. The skid steer loader 100 includes a loader bucket 106 for collecting material therein and transporting said material to a desired location. The loader bucket 106 is one of various work implements that can be attached to the skid steer loader 100. The loader bucket 106 can be pivotally coupled to a forward portion of a pair of boom arms 108 positioned on each side of the skid steer loader 100. A pair of tilt actuators 114 can extend between the loader bucket 106 and the boom arms 108 for controlling the tilted orientation of the loader bucket 106 with respect to the boom arms 108. Each tilt actuator 114 can include a cylinder rod that actuates back and forth within a cylinder in response to a hydraulic pressure. The operator can manipulate controls inside of the cab 112 to actuate the tilt actuators 114 allowing the operator to tilt the loader bucket 106 for dumping material therefrom.

In FIG. 1, the loader bucket 106 is shown at a minimum height. Both boom arms 108 are connected to the main frame 116 by an upper link 110 and a lower link 118. Hydraulic actuators 120 are pivotally secured at one end to the main frame 116 and coupled to the boom arms 108 at an opposite end thereof. Each hydraulic actuator 120 can include a cylinder rod that actuates back and forth within a cylinder in response to a hydraulic pressure. The operator can manipulate controls inside of the cab 112 to actuate the hydraulic actuators 120 to raise and lower the boom arms 108, which also raises and lowers the loader bucket 106.

Referring to FIG. 2, the skid steer loader 100 includes a drive train 128 that includes a right drive assembly 248 and a left drive assembly 250. The right drive assembly 248 and the left drive assembly 250 can be operated independently. The left drive assembly 250 drives a front ground engaging member 102 and a rear ground engaging member on the left side of the skid steer loader 100. The right drive assembly 248 drives a front ground engaging member 102 and a rear ground engaging member on the right side of the skid steer loader 100. The drive assemblies 248, 250 are mounted to a chassis 246 (i.e., frame). The main frame 116 and the front and rear ground engaging members 102, 104 are attached to the chassis 246.

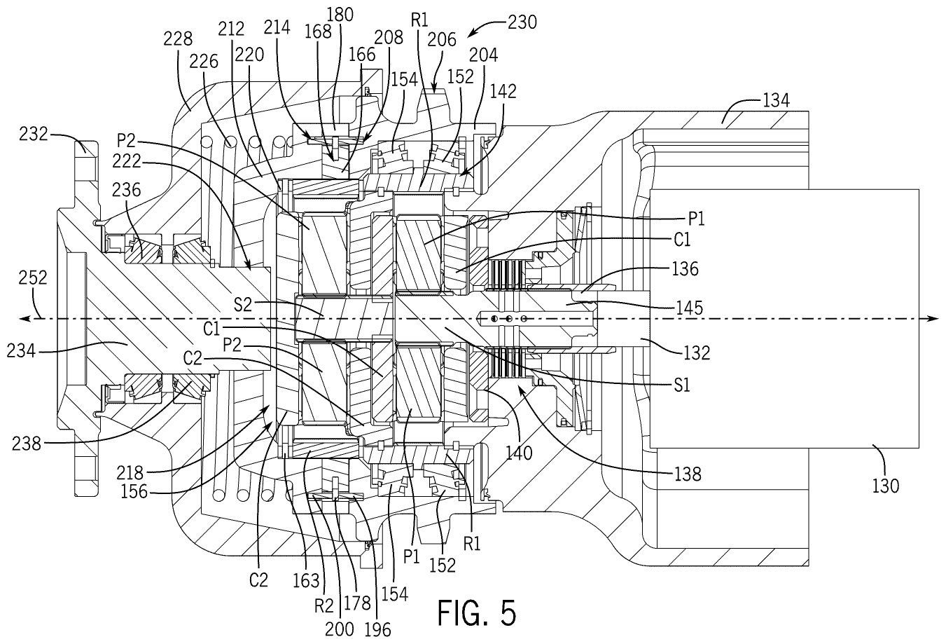

The left drive assembly 250 is identical to the right drive assembly 248. Since the drive assemblies 248, 250 are identical, only the left drive assembly 250 will be discussed in detail for the sake of brevity with the knowledge that the right drive assembly 248 is a mirror image of the left drive assembly 250. The left drive assembly 250 includes a motor 130, a gear assembly housing 134, a rear drive element 204, a continuous elongated member 244, a front output housing 228, a front hub 232, a second rear drive element 205, a rear output housing 229, and a rear hub 233. The motor 130 drives a gear assembly housing 134. The gear assembly housing 134 drives a limited differential assembly 230 (FIGS. 5-10) that is mostly positioned within a front output housing 228. The limited differential assembly 230 drives a front drive element 212 (FIGS. 5-7) and a rear drive element 204. The front drive element 212 is mechanically coupled to a front hub 232. The rear drive element 204 is connected to a second rear drive element 205 by a chain 244. In some alternative embodiments, the chain 244 can be a belt. The rear drive element 204 and the second rear drive element 205 both include a sprocket 206 that mechanically engages with the chain 244. Movement of the rear drive element 204 moves the chain 244 which in turn moves a second rear drive element 205. The second rear drive element 205 is coupled to drive a rear hub 233. The rear hub 233 is coupled to a rear output housing 229.

Each rear ground engaging member 104 can include a wheel 242 attached to the rear hub 233, and each front ground engaging member 102 can include a wheel 240 attached to the front hub 232. Rotation of the rear hub 233 rotates the rear ground engaging member 104 and rotation of the front hub 232 rotates the front ground engaging member 102. The ground engaging members 102, 104 are mounted to the chassis 246 through the drive assemblies 248, 250. In some aspects, the wheels 240 are the same size as the wheels 242. In some alternative aspects, the wheels 240 are a different size than the wheels 242.

Referring still to FIG. 2, the limited differential assembly 230 is positioned at the front ground engaging member 102 with the chain 244 connecting the limited differential assembly 230 to the rear round engaging member 104. In an alternative example the limited differential assembly can be positioned between the front ground engaging member 102 and the rear ground engaging member 104. In this example, the limited differential assembly would be connected to the front ground engaging member 102 with a first chain and the limited differential assembly would be connected to the rear ground engaging member 104 with a second chain. In yet another example, the limited differential assembly can be positioned at the rear ground engaging member 104 with a chain 244 connecting the limited differential assembly to the front ground engaging member 102. In any of these cases the limited differential assembly can be designed to either allow the front ground engaging member 102 or the rear ground engaging member 104 to slip and the respective other ground engaging member to be constantly driven by the limited differential assembly. In some alternative embodiments, the left drive assembly 250 can be designed to use a belt instead of a chain 244.

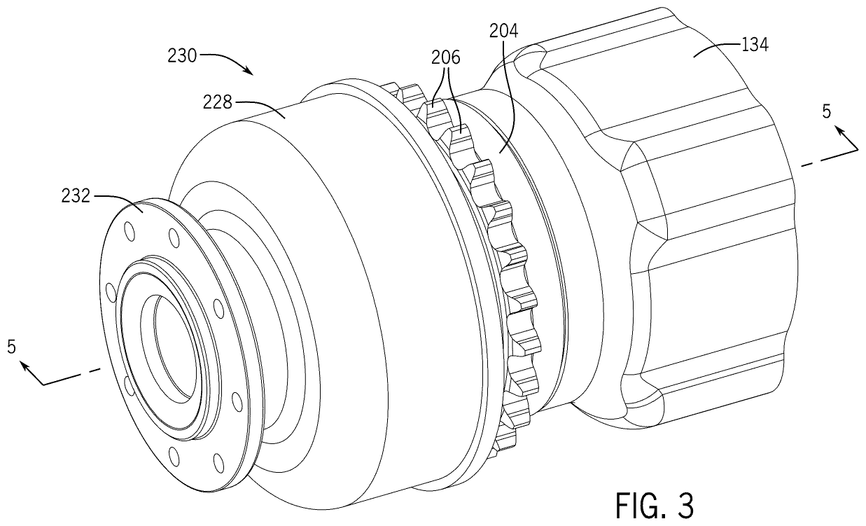

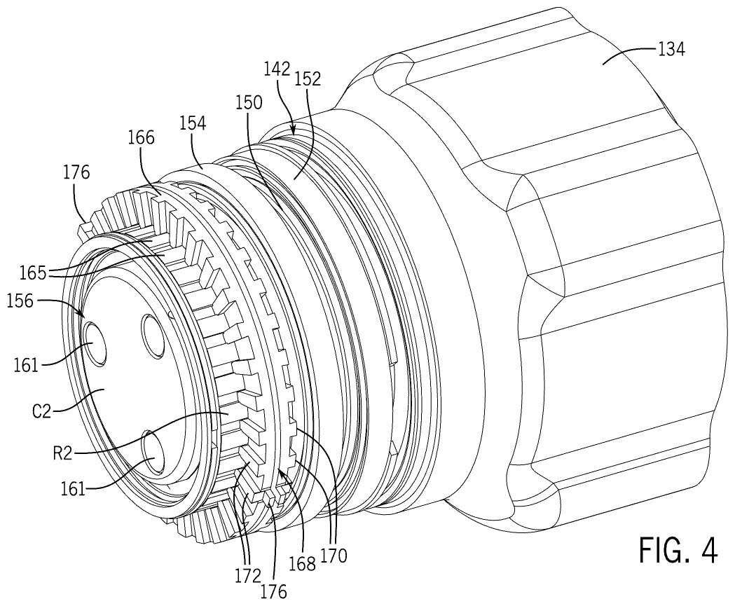

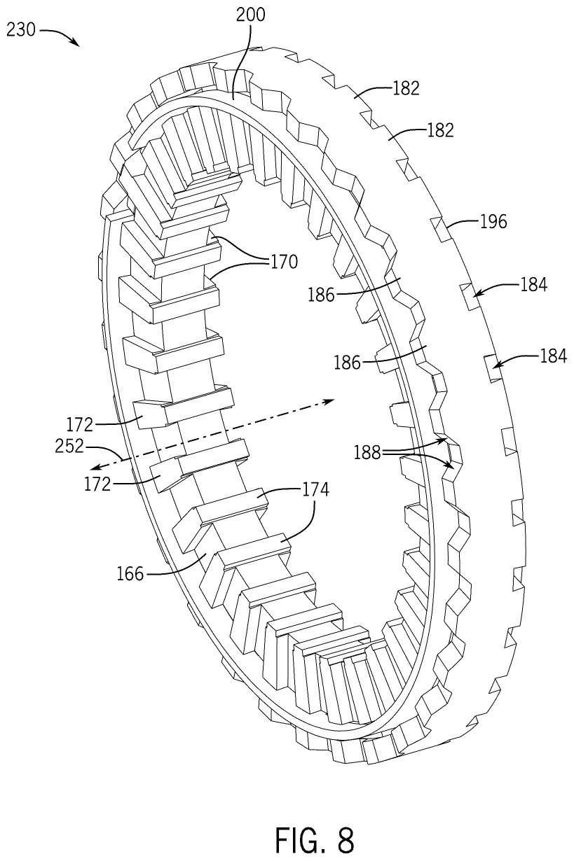

Referring also to FIG. 3, the gear assembly housing 134, rear drive element 204, the front output housing 228, and the front hub 232 are part of an exterior of the left drive assembly 250. The motor 130 couples to a gear assembly within the gear assembly housing 134. Referring to FIG. 4, the gear assembly includes a first planetary gear set 142 and a second planetary gear set 156. The motor 130 drives the gear assembly and the output of the gear assembly is a ring gear R2 of the second planetary gear set 156. The limited differential assembly 230 (FIGS. 5-9) is driven by the ring gear R2. For example, the ring gear R2 has splines 165 along the outer circumference of the ring gear R2 that mechanically engage with inner splines 174 (FIG. 8) along an inner circumference of a power transmission ring 166 of the limited differential assembly 230.

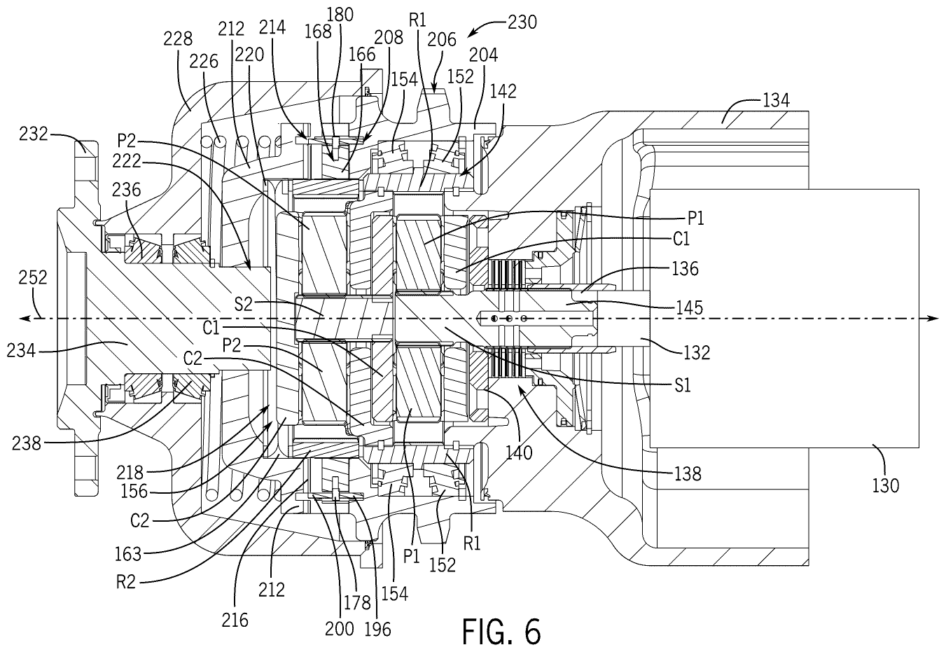

Referring also to FIGS. 5 and 6, the motor 130 drives the first planetary gear set 142 that drives the second planetary gear set 156 that drives the limited differential assembly 230. The limited differential assembly 230 drives the front and rear ground engaging members 102, 104, while always supplying power to the rear ground engaging member 104 and allowing the front ground engaging member 102 to under some conditions slip and rotate at a different speed than the rear ground engaging member 104.

The first planetary gear set 142 includes a sun gear S1, planetary gears P1, a carrier C1, and a ring gear R1. The second planetary gear set 156 includes a sun gear S2, a carrier C2, planetary gears P2, and a ring gear R2. A motor shaft 132 of the motor 130 is coupled to a shaft 145 of the sun gear S1 by a coupler 136, which allows the motor 130 to drive the sun gear S1. The shaft 145 extends through a braking system 138 and through a brake retainer 140. The braking system 138 can be used to slow and/or stop the left drive assembly 250, which in turn slows and/or stops the skid steer loader 100.

The shaft 145 ends with the gear teeth of the sun gear S1, where the gear teeth are positioned inside of the carrier C1. The sun gear S1 is surrounded and mechanically engaged with planetary gears P1. For example, the gear teeth of the sun gear S1 are mechanically engaged with the gear teeth of the planetary gears P1. Each planetary gear P1 is attached to the carrier C1 by a pin (not shown). The planetary gears P1 are positioned within the carrier C1 such that a pin extends through one side of the carrier C1, through a planetary gear P1, and into the opposing side of the carrier C1.

In the first planetary gear set 142, the ring gear R1 is held in a fixed position. In some aspects, the ring supports 152, 154 hold the ring gear R1 in the fixed position. Since the ring gear R1 is held in position, the rotation of the sun gear S1 causes the planetary gears P1 to rotate around the sun gear S1, which in turn causes the carrier C1 to rotate around the sun gear S1.

The sun gear S2 is attached to the carrier C1. The sun gear S2 is surrounded and mechanically engaged with planetary gears P2. For example, the gear teeth of the sun gear S2 are mechanically engaged with the gear teeth of the planetary gears P2. Each planetary gear P2 is attached to the carrier C2 by a pin 161 (FIG. 4). The planetary gears P2 are positioned within the carrier C2 such that the pin 161 extends through one side of the carrier C2, through a planetary gear P2 and into the opposing side of the carrier C2. The planetary gears P2 extends through the carrier C2 and are mechanically engaged with the ring gear R2. The carrier C2 is held in a fixed position allowing the planetary gears P2 to rotate but not move around the sun gear S2. For example, the carrier C2 can be attached to the ring gear R1 to hold the carrier C2 in position. Since the carrier C2 is held in position, the rotation of the sun gear S2 causes the planetary gears P2 to rotate causing the ring gear R2 to rotate around the sun gear S2. The ring gear R2 is the output of the gear assembly that drives the limited differential assembly 230.

Referring still to FIGS. 5 and 6, the ring gear R2, the sun gear S1, the sun gear S2, and the motor shaft 132 all rotate about a drive axis 252. In some alternative embodiments, the different components of the gear assembly and motor 130 do not need to rotate on the same drive axis as the ring gear R2.

The ring gear R2 is mechanically engaged with the power transmission ring 166 of the limited differential assembly 230. For example, the ring gear R2 has splines 165 along the outer circumference of the ring gear R2 that mechanically engage with inner splines 174 along an inner circumference of the power transmission ring 166. The movement of the power transmission ring 166 drives the limited differential assembly 230, which drives a front ground engaging member 102 and a rear ground engaging member 104. In some alternative examples, a different gear assembly could be used to produce an output that couples with the power transmission ring 166 to drive the limited differential assembly 230. For example, an output of the different gear assembly can be mechanically engaged with the inner splines 174.

Referring also to FIGS. 5-10, the limited differential assembly 230 includes the power transmission ring 166, a disconnect ring 180, a front drive element 212, and a rear drive element 204. As shown in FIGS. 5, 6, and 8, the power transmission ring 166 is positioned within the inner circumference of the disconnect ring 180. The power transmission ring 166 includes an outer circumference engaging feature that is mechanically engaged with an inner circumference engaging feature of the disconnect ring 180. As such, the disconnect ring 180 is driven by the power transmission ring 166 due to the mechanical engagement of the outer circumference engaging feature and the inner circumference engaging feature such that movement of the power transmission ring moves the disconnect ring.

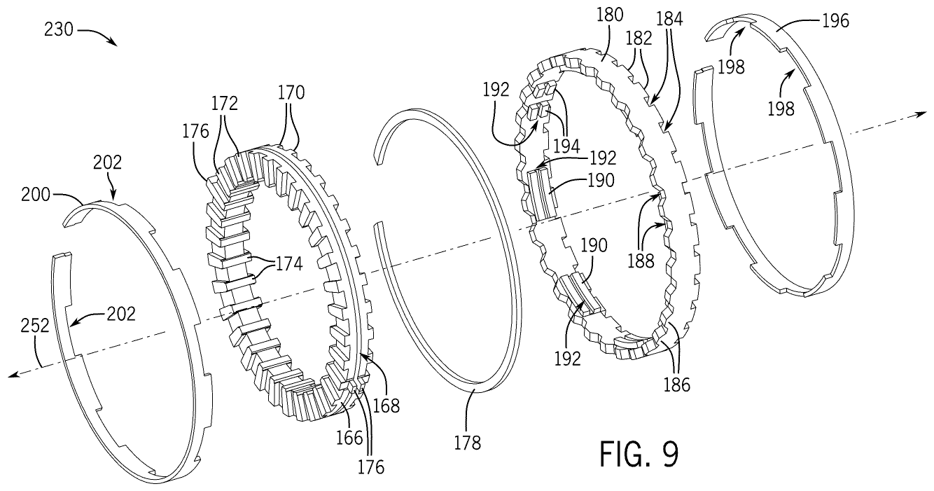

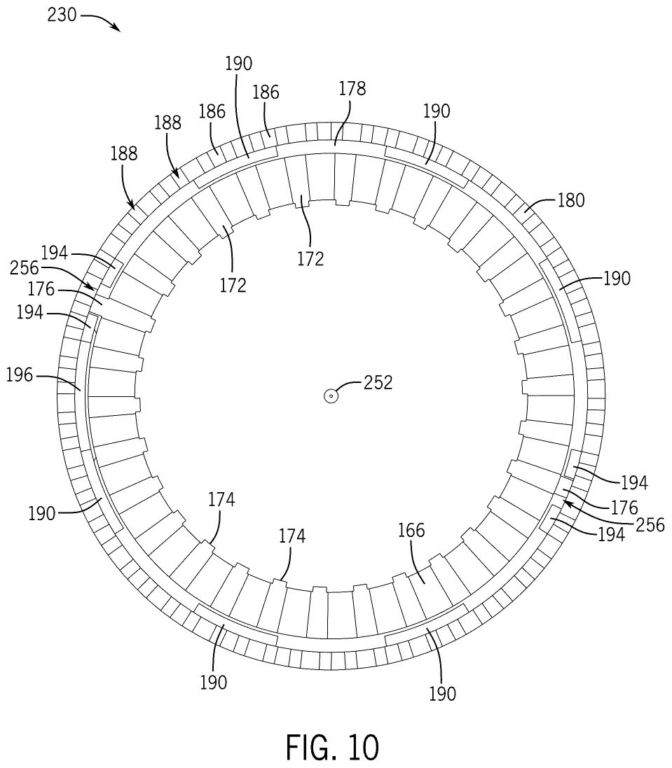

Referring also to FIGS. 9 and 10, the outer circumference engaging feature includes protrusions 176 and the inner circumference engaging feature includes protrusions 194. The power transmission ring 166 is positioned within the disconnect ring 180 such that protrusions 176 are positioned between a gap 256 in the protrusions 194. When the power transmission ring 166 rotates, the protrusions 176 moves across the gap 256 and into engagement with protrusions 194, and upon engagement, the disconnect ring 180 begins to rotate along with the power transmission ring 166 around the drive axis 252. As such, the power transmission ring 166 can move some distance before the disconnect ring 180 moves. In an alternative example, the outer circumference engaging feature could be splines or gear teeth that mechanically engage with splines or gear teeth of the inner circumference engaging feature.

Referring still to FIGS. 9 and 10, the limited differential assembly 230 further includes a snap ring 178. The disconnect ring 180 includes protrusions 190 spaced along the inner circumference of the disconnect ring 180. Each protrusion 190 has a channel in the middle and similarly the protrusions 194 have a channel in the middle. The channels in the protrusions 190, 194 together form a radial channel 192 along the inner circumference of the disconnect ring 180. The power transmission ring 166 has a radial channel 168 along the outer circumference of the power transmission ring 166. When the power transmission ring 166 is positioned within the disconnect ring 180, the radial channel 192 is aligned with the radial channel 168 to form a single radial channel that can hold a snap ring 178. The snap ring 178 is positioned within the radial channels 168, 192 to maintain alignment of the disconnect ring 180 and the power transmission ring 166. In one aspect, the radial channels 168, 192 are positioned in the center of the disconnect ring 180 and the power transmission ring 166. In an alternative aspect, the radial channels 168, 192 are offset from the center of the disconnect ring 180 and the power transmission ring 166.

The snap ring 178 can be installed onto the power transmission ring 166 and compressed into the radial channel 168 to allow the power transmission ring 166 to be positioned inside the disconnect ring 180 and when in the appropriate position, the snap ring 178 will snap out into the radial channel 192. When the power transmission ring 166 is properly positioned within the disconnect ring 180, a portion of the snap ring 178 will be positioned within both radial channels 168, 192, as best shown in FIGS. 5 and 6.

The example limited differential assembly 230 shows the power transmission ring 166 and the disconnect ring 180 as separable components, in an alternative example, the power transmission ring 166 and the disconnect ring 180 could be designed as a single component. For example, a single component could be made to perform the actions of the power transmission ring 166 and the disconnect ring 180 positioned together.

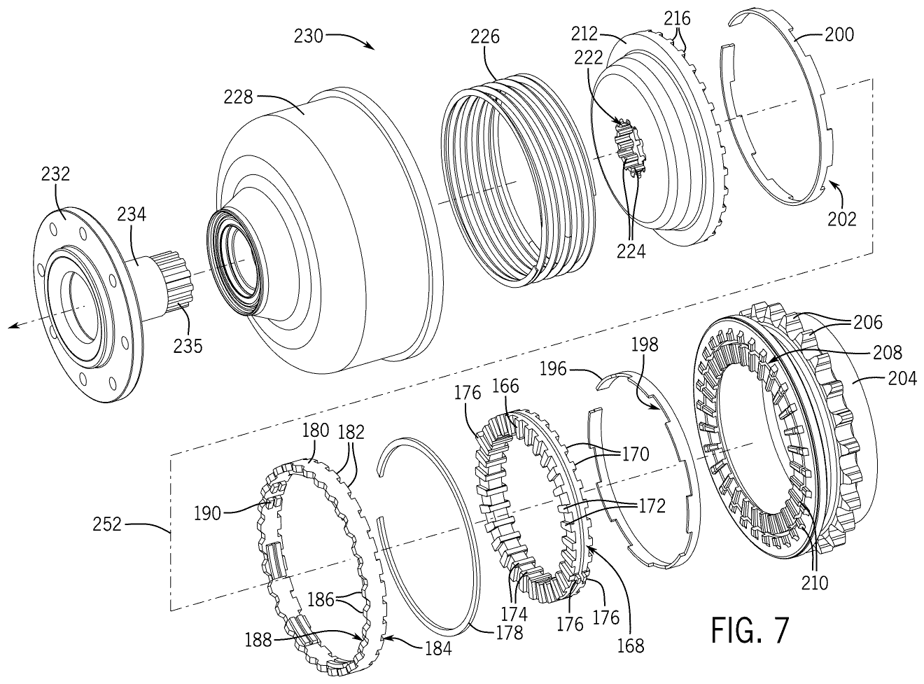

Referring also to FIGS. 7-9, the limited differential assembly 230 further includes locating rings 196, 200. When the power transmission ring 166 is positioned within the disconnect ring 180, there is a gap between the power transmission ring 166 and the disconnect ring 180. In at least one aspect, the gap is due to the protrusions 176, 190, 194. The snap ring 178 is positioned to split the gap and forms a channel on each side of the combined power transmission ring 166 and disconnect ring 180. As shown in FIG. 8, the locating rings 196, 200 are positioned in these channels. The locating rings 196, 200 include cutouts 198, 202, respectively. When the locating rings 196, 200 are positioned in the channels, the protrusions 176, 190, 194, rest in the cutouts 198, 202. In some aspects, the locating rings 196, 200 rest against the snap ring 178.

Referring back to FIGS. 5-7, as stated previously, the limited differential assembly 230 includes the rear drive element 204. The rear drive element 204 is always in mechanical engagement with the disconnect ring 180. During movement of the disconnect ring 180, the rear drive element 204 is also in mechanical engagement with the power transmission ring 166. The rear drive element 204 includes radial splines 210 that are mechanically engaged with radial splines 182 of the disconnect ring 180 and radial splines 170 of the power transmission ring 166. In some aspects, the radial splines 182 of the disconnect ring 180 have back tapering 184 to promote maintaining the radial splines 182 in engagement with the radial splines 210 of the rear drive element 204.

The radial splines 210 are sized and positioned to always be mechanically engaged with the radial splines 182 of the disconnect ring 180, such that movement of the disconnect ring 180 moves the rear drive element 204. However, the radial splines 170 of the power transmission ring 166 are sized and positioned to not always be mechanically engaged with the radial splines 210 of the rear drive element 204. For example, as discussed previously regarding FIG. 10, the power transmission ring 166 rotates to move protrusions 176 across the gap 256 and into engagement with protrusions 194 to move the disconnect ring 180. As such, the power transmission ring 166 can move some distance before the disconnect ring 180 moves. The spacing and size of the radial splines 170 are such that the radial splines 170 of the power transmission ring 166 are mechanically engaged with the radial splines 210 of the rear drive element 204 at the same time that the protrusions 176 engage protrusions 194 to move the disconnect ring 180. As such, the power transmission ring 166, the disconnect ring 180, and the rear drive element 204 can all rotate together about the drive axis 252.

The rear drive element 204 defines an axial channel 208. As shown in FIG. 7, the axial channel 208 is positioned such that it cuts through the radial splines 210. The portions of the radial splines 210 outside the outer circumference of the axial channel 208 mechanically engage the disconnect ring 180 and the portions of the radial splines 210 inside the inner circumference of the axial channel 208 mechanically engage the power transmission ring 166. The axial channel 208 is used to align the rear drive element 204 with the disconnect ring 180 and power transmission ring 166. As shown in FIGS. 5 and 6, the rear drive element 204 is positioned adjacent the power transmission ring 166 such that the axial channel 208 aligns with the gap between the disconnect ring 180 and power transmission ring 166 to form a single channel that the locating ring 196 is positioned. For example, the locating ring 196 is positioned within the axial channel 208 and gap to maintain alignment between the rear drive element 204, disconnect ring 180, and power transmission ring 166. As shown in FIGS. 5 and 6, at least a portion of the locating ring 196 is always positioned within the gap and axial channel 208.

In some aspects, the rotation of the power transmission ring 166 causes the locating ring 196 to rotate with the power transmission core 254. For example, the locating ring 196 rotates with the power transmission ring 166 due to the protrusions 190 and 194 mechanically engaging with the cutouts 198 in the locating ring 196.

The rear drive element 204 further includes a sprocket 206. As discussed regarding FIG. 2, the sprocket 206 is designed to mechanically engaged with a chain 244 to transfer movement of the rear drive element 204 to a rear ground engaging member 104 at a different location on the work vehicle. For example, rotation of the rear drive element 204 can be transferred to a second rear drive element 205 through a chain 244, where the second rear drive element 205 is coupled to the rear ground engaging member 104. A sprocket 206 may be positioned on both the rear drive element 204 and the second rear drive element 205. The sprocket 206 can mate with the chain 244. In some alternative embodiments, the sprocket and chain could be replaced with a sprocket and a toothed belt, a pulley and a belt, a spline and a toothed belt, or a gearing assembly.

Referring still to FIGS. 5-7 and as stated previously, the limited differential assembly 230 includes the front drive element 212. The front drive element 212 can move between an engaged position and a disengaged position. FIG. 5 shows the front drive element 212 in the engaged position and FIG. 6 shows the front drive element 212 in the disengaged position. In the engaged position, the front drive element 212 is mechanically engaged with the power transmission ring 166 and rotation of the front drive element 212 is driven by the power transmission ring 166. In the disengaged position, the front drive element 212 has moved out of engagement with the power transmission ring 166 and the front drive element 212 is no longer driven by the power transmission ring 166 and can rotate at a different speed than the power transmission ring 166. In either the engaged position or the disengaged position, the rear drive element 204 is mechanically engaged with the power transmission ring 166.

In the engaged position, the front drive element 212 is in mechanical engagement with the disconnect ring 180. Additionally, in the engaged position, the front drive element 212 is also in mechanical engagement with the power transmission ring 166 during movement. The front drive element 212 includes radial splines 216 that, in the engaged position, are mechanically engaged with radial splines 186 of the disconnect ring 180 and radial splines 172 of the power transmission ring 166. The radial splines 216 are sized and positioned to be mechanically engaged with the radial splines 186 of the disconnect ring 180, in the engaged position, such that movement of the disconnect ring 180 moves the front drive element 212. The radial splines 186 include cam surfaces 188 on each side of every radial spline 186 that form a cam interface, best viewed in FIGS. 8 and 9. In the engaged position, the radial splines 216 of the front drive element 212 are mechanically engaged with the cam surface 188 of the radial splines 186 of the disconnect ring 180.

The radial splines 172 of the power transmission ring 166 are sized and positioned to, even in the engaged position, not always be mechanically engaged with the radial splines 216 of the front drive element 212. For example, as discussed previously regarding FIG. 10, the power transmission ring 166 rotates to move the protrusions 176 across the gap 256 and into engagement with protrusions 194 to move the disconnect ring 180. As such, the power transmission ring 166 can move some distance before the disconnect ring 180 moves. The spacing and size of the radial splines 172 are such that the radial splines 172 of the power transmission ring 166 are mechanically engaged, in the engaged position, with the radial splines 216 of the front drive element 212 at the same time that the protrusions 176 engage protrusions 194 to move the disconnect ring 180. As such, in the engaged position, the power transmission ring 166, the disconnect ring 180, the rear drive element 204, and the front drive element 212 can all rotate together about the drive axis 252.

The front drive element 212 defines an axial channel 214, best viewed in FIGS. 5 and 6. The axial channel 214 is positioned such that it cuts through the radial splines 216. The portions of the radial splines 216 outside the outer circumference of the axial channel 214 can mechanically engage the disconnect ring 180 and the portions of the radial splines 216 inside the inner circumference of the axial channel 214 can mechanically engage the power transmission ring 166. The axial channel 214 is used to align the front drive element 212 with the disconnect ring 180 and power transmission ring 166. As shown in FIGS. 5 and 6, the front drive element 212 is positioned adjacent the power transmission ring 166 opposite the rear drive element 204. The axial channel 214 aligns with the gap between the disconnect ring 180 and power transmission ring 166 to form a single channel that the locating ring 200 is positioned. For example, the locating ring 200 is positioned within the axial channel 214 and gap to maintain alignment between the front drive element 212, disconnect ring 180, and power transmission ring 166. As shown in FIGS. 5 and 6, at least a portion of the locating ring 200 is always positioned within the gap and axial channel 214 in both the engaged position and the disengaged position. As such, the locating ring 200 maintains alignment between the front drive element 212, the disconnect ring 180, and the power transmission ring 166 in both the engaged position and the disengaged position.

In some aspects, the rotation of the power transmission ring 166 causes the locating ring 200 to rotate with the power transmission ring 166. For example, the locating ring 200 rotates with the power transmission ring 166 due to the protrusions 190 and 194 mechanically engaging with the cutouts 202 in the locating ring 200.

As shown in FIGS. 5 and 6, the axial channel 214 aligns with the axial channel 208. Locating rings 200, 196 are positioned within the axial channels 214, 208, respectively. The locating rings 200, 196 maintain alignment of the front drive element 212, the rear drive element 204, the disconnect ring 180, and the power transmission ring 166 along the drive axis 252. The radial channel 168 is positioned between the axial channel 214 and the axial channel 208. As such, the snap ring is positioned between the axial channel 214 and the axial channel 208.

The front drive element 212, the rear drive element 204, the disconnect ring 180, and the power transmission ring 166 are aligned and rotate about the drive axis 252. The rear drive element 204 is positioned on the drive axis 252 on one side of the disconnect ring 180 and power transmission ring 166, and the front drive element 212 is positioned on the drive axis 252 on the opposite side of the disconnect ring 180 and power transmission ring 166. The front drive element 212 includes an annular member (e.g. radial splines 216) that can mechanically engage with the disconnect ring 180 and power transmission ring 166. The rear drive element 204 includes an annular member (e.g. radial splines 210) that can mechanically engage with the disconnect ring 180 and power transmission ring 166.

The front output housing 228 surrounds the front drive element 212, the disconnect ring 180, and the power transmission ring 166. The front output housing 228 can be coupled to the rear drive element 204 so that the front output housing 228 remains laterally fixed relative to the rear drive element 204. In one aspect, the rear drive element 204 can rotate relative to the front output housing 228.

The front hub 232 includes a shaft 234 that extends through a center hole in the front output housing 228. Bearings 236, 238 allow the front hub 232 to rotate smoothly relative to the front output housing 228. The front drive element 212 is mechanically coupled to the front hub 232, where movement of the front drive element 212 drives the front hub 232. For example, front drive element 212 defines a hole 222 in the middle of the front drive element 212, where splines 224 are spaced along the circumference of the hole 222. As shown in FIGS. 5 and 6, the shaft 234 of the front hub 232 extends through the hole 222. The splines 235 mesh with the splines 224 to couple the front drive element 212 to the front hub 232. As such, the front drive element 212 drives the front hub 232. A ground engaging member 102 can be attached to the front hub 232. Rotation of the front drive element 212 causes the ground engaging member 102 to rotate.

A biasing member 226 can be positioned within the front output housing 228 between an interior surface of the front output housing 228 and the front drive element 212. In at least one aspect, the biasing member 226 is a spring. The biasing member 226 can apply a biasing force to the front drive element 212 to push the front drive element 212 toward the power transmission ring 166. As such, the biasing force can push the front drive element 212 into the engaged position and maintain the front drive element 212 in the engaged position, as shown in FIG. 5. For the front drive element 212 to transition to the disengaged position, the front drive element 212 must overcome the biasing force and compress the biasing member 226 moving the front drive element 212 away from the power transmission ring 166 until the front drive element 212 is in the disengaged position, as shown in FIG. 6. In the disengaged position, the front drive element 212 is no longer in mechanical engagement with the power transmission ring 166. As the front drive element 212 moves away from the power transmission ring 166, the locating ring 200 maintains alignment of the front drive element 212 with the power transmission ring 166. Additionally, through both the engaged position and the disengaged position, the rear drive element 204 is driven by the power transmission ring 166.

The front drive element 212 includes a concave inner surface 218 where there is a ledge 220 defined circumferentially around the concave inner surface 218. The concave inner surface 218 provides space for the second planetary gear set 156 to be partially surrounded by the front drive element 212. A biasing member 163 is positioned between the ledge 220 and the ring gear R2. As stated previously, the ring gear R2 is the output of the second planetary gear set 156. In both the engaged position and the disengaged position, the biasing member 163 applies a biasing force on the ring gear R2 to hold the ring gear R2 in position. For example, as the front drive element 212 moves from the engaged position to the disengaged position moving physically away from the power transmission ring 166, the biasing member 163 expands applying a biasing force on the ring gear R2 to hold the ring gear R2 in position. Similarly, the biasing member 163 contracts as the front drive element 212 moves from the disengaged position to the engaged position. In at least one aspect, the biasing member 163 is a spring.

Referring still to FIGS. 5-7, the front drive element 212 can automatically (i.e., passively) transition from the engaged position (FIG. 5) to the disengaged position (FIG. 6) based on interactions between the front ground engaging member 102 and the surface of the ground. The conditions of the terrain (e.g. rough terrain, soft terrain, etc.), tread wear, or size of the ground engaging members 102, 104 of the skid steer loader 100 can cause the ground surface to interact with the different ground engaging members 102, 104 differently. As such, to improve traction between the ground engaging members 102, 104 and the ground surface it can be advantageous to allow different ground engaging members 102, 104 to rotate at different speeds, even when those ground engaging members 102, 104 are mechanically driven by the same motor 130. The limited differential assembly 230 is driven by a motor 130 and drives the front ground engaging member 102 and the rear round engaging member 104 while allowing the front ground engaging member 102 to rotate at a different speed in the disengaged position.

In the engaged position, the front drive element 212 and the rear drive element 204 are driven by the power transmission ring 166. The front drive element 212 is mechanically coupled to drive a front ground engaging member 102 and the rear drive element 204 is mechanically coupled to drive a rear ground engaging member 104. As such, in the engaged position, the power transmission ring 166 drives the front and rear ground engaging members 102, 104 to move the skid steer loader 100. In the engaged position, the front ground engaging member 102 and the rear ground engaging member 104 rotate at the same speed. In the disengaged position, the power transmission ring 166 drives the rear ground engaging member 104 to move the skid steer loader 100 and the front ground engaging member 102 rotates based on the interactions between the front ground engaging member 102 and the ground surface as the skid steer loader 100 moves. Therefore, the front ground engaging member 102 and the rear ground engaging member 104 can rotate at different speeds. Additionally, the front drive element 212 can rotate at a different speed than the rear drive element 204.

The front drive element 212 can move from the engaged position to the disengaged position based on the interactions between the ground surface and the front ground engaging member 102. These interactions generate a force (e.g. a rotational force) on the front ground engaging member 102 as the skid steer loader 100 moves. For example, the skid steer loader 100 may be in a muddy terrain condition, where the front ground engaged member 102 is in mud and the rear ground engaging member 104 is in on solid ground, and the difference in the terrain at the front and rear ground engaging members 102, 104 can cause the front ground engaging member 102 to have a different traction than the rear ground engaging member 104 and as such receive a different force through interactions with the ground. Rotational forces applied to the front ground engaging member 102 through interactions with the surface of the ground can be applied to the front drive element 212 through the mechanical coupling. For example, a rotational force applied to the front ground engaging member 102 can transfer through the mechanical coupling to apply a rotational force to the front drive element 212 based on the rotational force at the front ground engaging member 102.

As stated previously regarding FIGS. 8 and 9, in the engaged position, the radial splines 216 of the front drive element 212 are mechanically engaged with the disconnect ring 180 at cam surfaces 188. In the engaged position, the power transmission ring 166 applies a first rotational force to drive the front drive element 212 and the rear drive element 204. A second rotational force can be generated by the interactions between the ground and the front ground engaging member 102, where the second rotational force is also applied at the front drive element 212. The second rotational force can cause the front drive element 212 to rotate at a speed different than the power transmission ring 166 and the rear drive element 204 causing the front drive element 212 to perform a cam action at the cam surfaces 188. For example, the second rotational force can cause the radial splines 216 to slide along the cam surfaces 188. The camming movement of the radial splines 216 moves the front drive element 212 away from the power transmission ring 166 and compresses the biasing member 226. The biasing member 226 applies a biasing force to the front drive element 212 pushing the front drive element 212 toward the power transmission ring 166. As such, the second rotational force must overcome this biasing force for the front drive element 212 to perform a camming action at the cam surfaces 188 and move away from power transmission ring 166.

The camming movement moves the front drive element 212 from the engaged position toward the disengaged position. The front drive element 212 is placed in the disengaged position when the camming movement causes the front drive element 212 to move along the cam surfaces 188 and out of engagement with the power transmission ring 166. The disconnect ring 180 provides the camming interface that allows the front drive element 212 to perform a camming action to move from the engaged position to the disengaged position. For example, the front drive element 212 is placed in the disengaged position when the radial splines 216 move the entire length of the cam surfaces 188 and out of engagement with the disconnect ring 180 and the power transmission ring 166.

In the disengaged position, the front drive element 212 and the front ground engaging member 102 rotated at a different speed than the rear drive element 204 and the rear ground engaging member 104, respectively. As such, in the disengaged position, the rear drive element 204 and the rear ground engaging member 104 are driven by the motor 130 to move the skid steer loader 100, while the front ground engaging member 102 and the front drive element 212 are driven by the movement of the skid steer loader 100 in combination with interactions between the ground surface and the front ground engaging member 102. The rear ground engaging member 104 and the front ground engaging member 102 are both mounted to the skid steer loader 100; therefore, as the skid steer loader 100 moves the speed of the rear ground engaging member 104 and the front ground engaging member 102 will eventually begin to rotate at a similar speed. As the speed of the rear drive element 204 and the front drive element 212 move closer together, the biasing force caused by the biasing member 226 will push the front drive element 212 back into the engaged position. For example, the second rotational force will become small enough that the biasing force will no longer be overcome, and the biasing force will move the front drive element 212 toward the power transmission ring 166 and into the engaged position. In this way, the front drive element 212 will perform another camming action along the cam surfaces 188 to move back into the engaged position. The front drive element 212 is in the engaged position the moment the radial splines 216 of the front drive element 212 are mechanically engaged with the cam surface 188. At this point the front drive element 212 is being driven by the power transmission ring 166. The front drive element 212 can be in the engaged position, while the radial splines 216 slide along the cam surface 188. For example, the front drive element 212 can be in the engaged position and perform a camming action along the cam surfaces 188 moving further into the engaged position. Through both the engaged position and the disengaged position, the rear drive element 204 and the rear ground engaging member 104 are driven by the power transmission ring 166.

While the example limited differential assembly 230 allows the front drive element 212 to slip, one of ordinary skill in the art can use the described approach to design a limited differential assembly 230 that allows the rear drive element to slip. Additionally, minor changes can be made to the design to position the limited differential assembly 230 at a different physical location on the work vehicle. For example, the limited differential assembly 230 can be coupled to the front and/or rear ground engaging members with a chain, a belt, or a gearing system.

Although the present disclosure has been described with reference to example implementations, workers skilled in the art will recognize that changes may be made in form and detail without departing from the spirit and scope of the claimed subject matter. For example, although different example implementations may have been described as including features providing one or more benefits, it is contemplated that the described features may be interchanged with one another or alternatively be combined with one another in the described example implementations or in other alternative implementations. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure. Although portions of the disclosure may use the phrase “at least one” or “one or more” of a particular component or element, unless otherwise specifically limited, the mere recitation of a single element or component does not preclude a plurality of such elements or components.

What is claimed is:

1. A drive assembly for a work vehicle having a front ground engaging member and a rear ground engaging member, the drive assembly comprising:
a drive motor;
a gear assembly driven by the drive motor; and
a limited differential assembly including:
front and rear drive elements mechanically coupled to the respective front and rear ground engaging members;
a power transmission ring driven by the gear assembly to rotate around a drive axis; and
a disconnect ring mechanically coupled to the power transmission ring to rotate around the drive axis, the power transmission ring being coupled to the rear drive element to drive rotation of the rear ground engaging member, when the front drive element is in a first position, the power transmission ring is engaged with the front drive element to drive rotation of the front ground engaging member, and when the front drive element is in a second position, the power transmission ring is disengaged from the front drive element so as not to drive rotation of the front ground engaging member and permit the front and rear ground engaging members to rotate at different speeds.

2. The drive assembly of claim 1, wherein the limited differential assembly further comprises a biasing member to apply a biasing force to the front drive element to bias the front drive element toward the power transmission ring and into the first position, wherein the front drive element transitions from the first position to the second position based on a force generated by interactions between a ground surface and the front ground engaging member overcoming the biasing force, and wherein the interactions cause the front ground engaging member to rotate at a different speed than the rear ground engaging member.

3. The drive assembly of claim 2, wherein, in the first position, the front drive element is mechanically engaged with the disconnect ring at a cam interface, and wherein the front drive element transitions from the first position to the second position by cam action at the cam interface.

4. The drive assembly of claim 1, wherein, in the first position and in the second position, the power transmission ring comprises a plurality of radial splines mechanically engaged with a plurality of radial splines of the rear drive element.

5. The drive assembly of claim 1, wherein the front drive element is positioned along the drive axis on a first side of the limited differential assembly, and wherein the rear drive element is positioned along the drive axis on a second side of the limited differential assembly opposite the first side.

6. The drive assembly of claim 1, wherein the power transmission ring comprises a spline positioned on an inner circumference of the power transmission ring, wherein the spline is mechanically engaged with an output of the gear assembly, and wherein the power transmission ring is driven by the output of the gear assembly.

7. The drive assembly of claim 1, wherein the power transmission ring comprises an outer circumference engaging feature, wherein the disconnect ring comprises an inner circumference engaging feature, and wherein the disconnect ring is driven by the power transmission ring based on the outer circumference engaging feature mechanically engaging with the inner circumference engaging feature to transfer movement of the power transmission ring to the disconnect ring.

8. The drive assembly of claim 1, wherein the front drive element defines an axial channel, wherein the limited differential assembly further comprises a locating ring at least in part positioned in the axial channel, and wherein the locating ring maintains alignment of the front drive element and the disconnect ring in the first position and in the second position.

9. The drive assembly of claim 8, wherein the rear drive element defines a second axial channel aligned with the axial channel, wherein the limited differential assembly further comprises a second locating ring positioned in the second axial channel, and wherein the second locating ring maintains alignment of the rear drive element and the disconnect ring in the first position and in the second position.

10. The drive assembly of claim 9, wherein the power transmission ring and the disconnect ring together define a radial channel, wherein a snap ring is positioned within the radial channel to maintain alignment of the power transmission ring and the disconnect ring, and wherein the snap ring is positioned between the axial channel and the second axial channel.

11. The drive assembly of claim 1, wherein the rear drive element comprises a sprocket mechanically coupled to the rear ground engaging member by a continuous elongated member.

12. The drive assembly of claim 1, wherein the gear assembly is a planetary gear set.

13. A work vehicle comprising:
a chassis mounting a front ground engaging member and a rear ground engaging member; and
a drive assembly including:
a drive motor;
a gear assembly driven by the drive motor; and
a limited differential assembly including:
front and rear drive elements mechanically coupled to the respective front and rear ground engaging members;
a power transmission ring driven by the gear assembly to rotate around a drive axis; and
a disconnect ring mechanically coupled to the power transmission ring to rotate around the drive axis, the power transmission ring being coupled to the rear drive element to drive rotation of the rear ground engaging member, when the front drive element is in a first position, the power transmission ring is engaged with the front drive element to drive rotation of the front ground engaging member, and when the front drive element is in a second position, the power transmission ring is disengaged from the front drive element so as not to drive rotation of the front ground engaging member and permit the front and rear ground engaging members to rotate at different speeds.

14. The work vehicle of claim 13, wherein the front and rear ground engaging members are located at a first side of the work vehicle, and wherein the chassis mounts a second front ground engaging member and a second rear ground engaging member both located at a second side of the work vehicle opposite the first side;
wherein the work vehicle further comprises a second drive assembly for driving rotation of the second front and rear ground engaging members independently of the drive assembly driving the front and rear ground engaging members, the second drive assembly including:
a second drive motor;
a second gear assembly driven by the second drive motor; and
a second limited differential assembly including:
a second front drive element and a second rear drive element mechanically coupled to the respective second front and rear ground engaging members;
a second power transmission ring driven by the second gear assembly to rotate around a second drive axis; and
a second disconnect ring mechanically coupled to the second power transmission ring to rotate around the second drive axis, the second power transmission ring being coupled to the second rear drive element to drive rotation of the second rear ground engaging member, when the second front drive element is in a first position, the second power transmission ring is engaged with the second front drive element to drive rotation of the second front ground engaging member, and when the second front drive element is in a second position, the second power transmission ring is disengaged from the second front drive element so as not to drive rotation of the second front ground engaging member and permit the second front and rear ground engaging members to rotate at different speeds.

15. The work vehicle of claim 13, wherein the limited differential assembly further comprises a biasing member to apply a biasing force to the front drive element to bias the front drive element toward the power transmission ring and into the first position, wherein the front drive element transitions from the first position to the second position based on a force generated by interactions between a ground surface and the front ground engaging member overcoming the biasing force, and wherein the interactions cause the front ground engaging member to rotate at a different speed than the rear ground engaging member.

16. The work vehicle of claim 15, wherein, in the first position, the front drive element is mechanically engaged with the disconnect ring at a cam interface, and wherein the front drive element transitions from the first position to the second position by cam action at the cam interface.

17. The work vehicle of claim 13, wherein, in the first position and in the second position, the power transmission ring comprises a plurality of radial splines mechanically engaged with a plurality of radial splines of the rear drive element.

18. The work vehicle of claim 13, wherein the front drive element is positioned along the drive axis on a first side of the limited differential assembly, and wherein the rear drive element is positioned along the drive axis on a second side of the limited differential assembly opposite the first side.

19. The work vehicle of claim 13, wherein the power transmission ring comprises a spline positioned on an inner circumference of the power transmission ring, wherein the spline is mechanically engaged with an output of the gear assembly, and wherein the power transmission ring is driven by the output of the gear assembly.

20. The work vehicle of claim 13, wherein the power transmission ring comprises an outer circumference engaging feature, wherein the disconnect ring comprises an inner circumference engaging feature, and wherein the disconnect ring is driven by the power transmission ring based on the outer circumference engaging feature mechanically engaging with the inner circumference engaging feature to transfer movement of the power transmission ring to the disconnect ring.
